(19) United States
(12) Patent Application Publication
(10) Pub. No.: US 2015/0122541 A1
(43) Pub. Date: May 7, 2015

(54) Conductor Component

(71) Applicant: SCHLUMBERGER TECHNOLOGY CORPORATION, SUGAR LAND, TX (US)

(72) Inventors: Joseph Varkey, Sugar Land, TX (US); Sheng Chang, Sugar Land, TX (US)

(73) Assignee: SCHLUMBERGER TECHNOLOGY CORPORATION, SUGAR LAND, TX (US)

(21) Appl. No.: 14/072,281

(22) Filed: Nov. 5, 2013

(51) Int. Cl. H01B 7/02; H01B 13/06; H01B 11/22

(52) U.S. Cl. CPC H01B 7/0216; H01B 11/22; H01B 13/06
USPC 174/70 R; 174/113 R; 174/117 R; 29/825

(57) ABSTRACT

A conductor having a first half and a second half. The first half has a first solid conductor. A first insulating layer is disposed about the first solid conductor. The second half has a second solid conductor. A second insulating layer is disposed about the second solid conductor. The first half and second half are engaged with one another, and an outer insulating layer is disposed about the first half and the second half.

### CROSS-REFERENCE TO RELATED APPLICATIONS

None.

### FIELD OF THE DISCLOSURE

The disclosure generally relates to conductor components, assemblies of conductor components, and a method of making conductor components.

### BACKGROUND

Oilfield operations often use remote equipment. The remote equipment may need to communicate with the surface, receive power from the surface, or both. Permanent monitoring cables are often used to provide communication and power to the remote equipment.

Permanent monitoring cables often have stranded copper conductors running parallel to one another inside an outer layer of insulation. The capacity of these types of permanent monitoring cables is often limited. Optical fibers can be used in conjunction with the cooper conductors. Optical fibers, however, are fragile and the incorporation of them into permanent monitoring cables is difficult.

A need therefore exists for conductor components that utilize solid conductors that can have a profile that increases the capacity of the permanent monitoring cables.

### SUMMARY

An embodiment of an example conductor component includes a first half, a second half, and an outer insulating layer disposed about the first half and the second half.

The first half includes a first solid conductor. A first insulating layer is disposed about the first solid conductor. The second half includes a second solid conductor, and a second insulating layer disposed about the second solid conductor. The first half and the second half are engaged with one another. The outer insulating layer is disposed about the first half and the second half.

An embodiment of an example assembly of conductor components includes a plurality of conductor components. Some of the conductor components of the plurality of conductor components includes a first half, a second half, and an insulating layer disposed about the first half and the second half.

The first half includes a first solid conductor, and a first insulating layer is disposed about the first solid conductor; the second half includes a second solid conductor, and a second insulating layer is disposed about the second solid conductor. The first half is engaged with the second half. A jacketing is disposed about the plurality of conductors.

An embodiment of an example method of making a conductor component includes disposing a first insulating layer about a first solid conductor, forming a first half; and disposing a second insulating layer about a second solid conductor, forming a second half. The method also includes engaging the first half with the second half. The method further includes disposing an outer insulating layer about the first half and the second half.

### BRIEF DESCRIPTION OF THE DRAWINGS

FIG. 1 depicts an example conductor component.

FIG. 2 depicts another example conductor component.

FIG. 3 depicts an example assembly of conductor components.

FIG. 4 depicts an example armored assembly having an example arrangement of strength members disposed thereabout.

FIG. 5 depicts another example armored assembly having another example arrangement of strength members disposed thereabout.

FIG. 6 depicts another example armored assembly having another example arrangement of strength members disposed thereabout.

FIG. 7 depicts an example assembly of conductor components arranged about a tubular member.

FIG. 8 depicts an example method of making a conductor component.

### DETAILED DESCRIPTION OF THE INVENTION

Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

An example conductor component includes a first half and a second half engaged with one another. The first half and the second half can have any profile. For example, the profiles of the halves can be semi-circular. In an embodiment, the first half can have a first concave portion, and the second half can have a second concave portion. The concave portions can form an opening when the first half is engaged with the second half. An optical fiber can be located in the opening. The optical fiber can be in a central tube. The central tube can be a sheath, a plastic tube, or the like.

The first half, of the example conductor component, can include a first solid conductor and a second solid conductor. The first solid conductor and the second solid conductor can be made from any conductive material. Illustrative conductive materials include copper, steel, and other metallic materials.

A first insulating layer is disposed about the first solid conductor, and a second insulating layer is disposed about the second solid conductor. The first insulating layer and the second insulating layer can be any insulating material that can shape-extrude the associated solid conductor into the desired profile. Illustrative materials include Fluoropolymers, Polyolefins, Polyarylether ketone family polymers, Polyphenylene family polymers, Olefin Block Copolymers, Polypropylene cross linked with thylene propylene diene monomer (EPDM) rubber, or the like.

The example conductor component also includes an outer insulating layer disposed about the first half and the second half. The outer insulating layer can be any material. Illustrative materials for the outer insulating layer include Fluoropolymers, Polyolefins, Polyarylether ketone family polymers, Polyphenylene family polymers, high temperature cross-linked epoxy, or the like.

An example assembly of conductor components can include a plurality of conductor components. Some of the conductor components can be similar to those disclosed herein; other conductor components can be other cable conductors. The conductor components can be arranged in any configuration. In one or more embodiments, the conductor components can be arranged in a twisted pair design.

The conductor components can be disposed about a tubular member, and an inner insulating layer can be disposed about the tubular member. The inner insulating layer can be located between the tubular member and the plurality of conductor components, and the conductor components can be cabled helically about the inner insulating layer.

The inner insulating layer can be any material. Illustrative materials for the inner insulating layer include Fluoropolymers, Polyolefins, Polyarylether ketone family polymers, Polyphenylene family polymers, high temperature cross-linked epoxy, or the like.

A jacketing is disposed about the plurality of conductor components. The jacketing can have a circular profile. The jacketing can be any material. Illustrative materials for the jacketing include Fluoropolymers, Polyolefins, Polyarylether ketone family polymers, Polyphenylene family polymers, high temperature cross-linked epoxy, or the like.

An intermediate insulating layer can be disposed about the plurality of conductor components. The intermediate insulating layer can be located between the jacketing and the plurality of conductor components.

In embodiments of the example assembly interstitial spaces can be formed between the conductor components of the plurality of conductor components, and the interstitial spaces can have a filler located therein. The filler can be any material. Illustrative materials include polymers, fibers, or the like.

An example method of making a conductor component includes disposing a first insulating layer about a first solid conductor, forming a first half; and disposing a second insulating layer about a second solid conductor, forming a second half.

The example method also includes engaging the first half with the second half; and disposing an outer insulating layer about the first half and the second half.

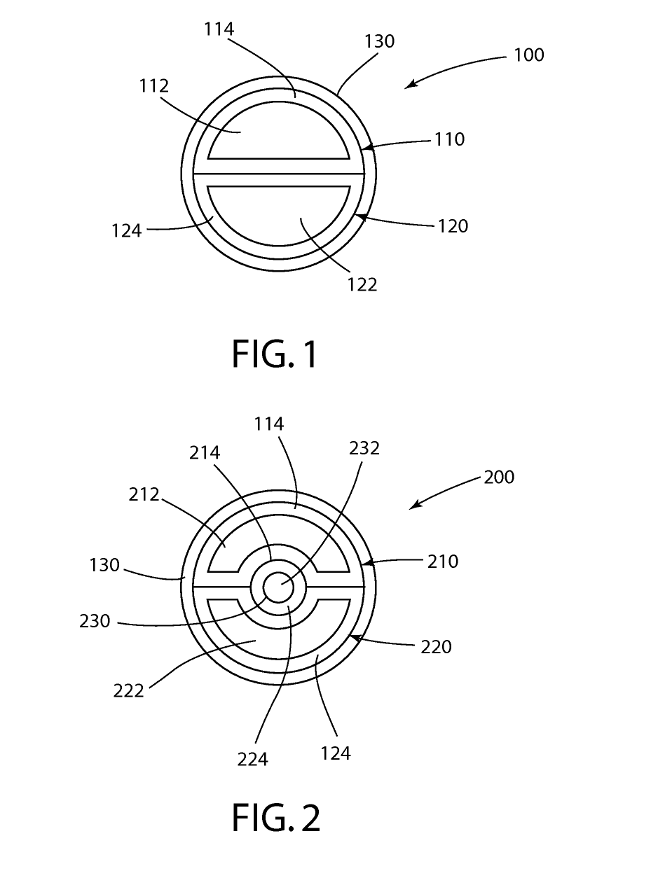

Turning now to the FIGS, FIG. 1 depicts an example conductor component. The conductor component 100 includes a first half 110 and a second half 120. The first half 110 and the second half 120 are depicted having a semi-circular profile.

The first half 110 includes a first solid conductor 112. The first solid conductor 112 has a first insulating layer 114 disposed thereabout. The first insulating 114 can shape-extrude the first solid conductor 112 into a semi-circular profile. The first insulating layer 114 can be made from any material.

The second half 120 has a second solid conductor 122. A second insulating layer 124 can be disposed about the second solid conductor 122. The second insulating layer 124 can shape-extrude the second solid conductor 122 into a semi-circular profile.

The first half 110 is engaged with the second half 120, and an outer insulating layer 130 is disposed about the first half 110 and the second half 120.

FIG. 2 depicts another example conductor component. The conductor component 200 has a first half 210 and a second half 220.

The first half 210 can have a first solid conductor 212. The first solid conductor 212 can have a first concave portion 214. The profile of the first solid conductor 212 can be referred to as a “clam-shell profile”. The first insulating layer 114 is disposed about the first solid conductor 212, and the first insulating layer 114 can shape-extrude the first solid conductor to the desired profile.

The second half 220 has a second solid conductor 222. The second solid conductor 222 has a second concave portion 224. The second insulating layer 124 can be disposed about the second solid conductor 222, and the second insulating layer 124 can shape-extrude the second solid conductor 222 into the desired profile. The first half 210 and the second half 220 can be engaged with one another, and the outer insulating layer 130 can be disposed about the first half 210 and the second half 220.

The concave portions 214 and 224 can form an opening 230 when the first half 210 is engaged with the second half 220. An optical fiber 232 can be located in the opening 230. The first solid conductor 212 and the second solid conductor 222 can protect the optical fiber 232 from damage. The optical fiber allows greater capacity for data transmission and can also be used for distributed sensing of temperature or pressure along the length of a cable formed using the conductor components. The optical fiber can be located in a central tube. The central tube can be metallic or polymeric.

The conductor component 200 can be made by extruding the first insulating layer 114 over the first solid conductor 212 and extruding the second insulating layer 124 over the second sold conductor 222, forming the first half 210 and the second half 220. The halves 210 and 220 can be brought together over the optical fiber 232. The outer insulating layer 130 can be extruded about the engaged halves 210 and 220.

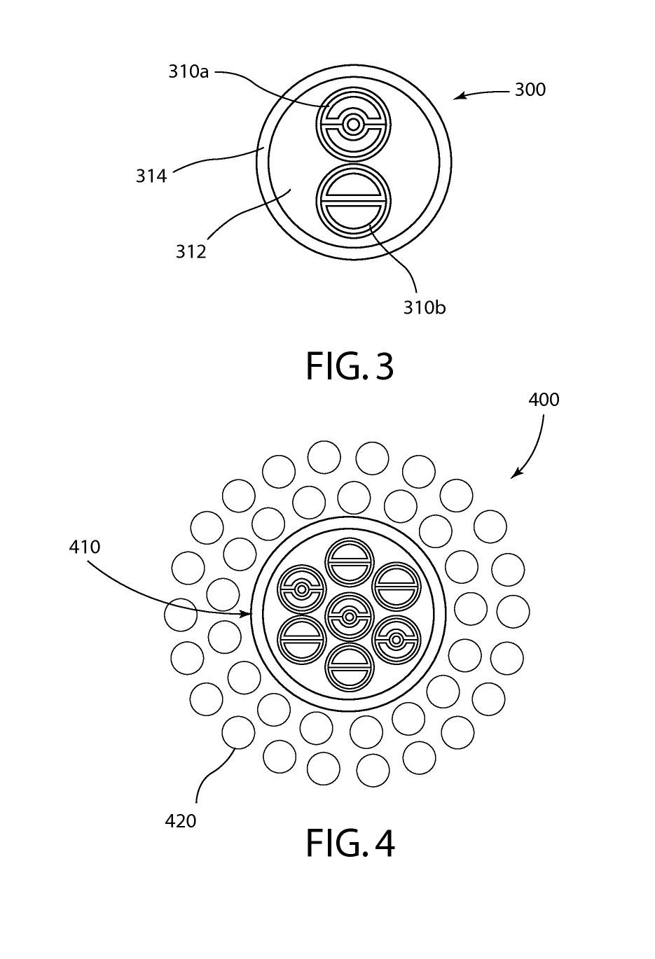

FIG. 3 depicts an example assembly of conductor components. The assembly 300 can include a first conductor component 310a and a second conductor component 310b. The conductor components 310a and 310b can be one of those disclosed herein. The conductor components 310a and 310b can be cabled together.

An intermediate insulating layer 312 is disposed about the conductor components 310a and 310b. The intermediate insulating layer 312 creates a circular profile for the assembly. The intermediate insulating layer 312 can be extruded about the conductor components 310a and 310b. The intermediate insulating layer 312 can be fiber reinforced. The intermediate insulating layer 312 has a jacket 314 disposed thereabout. The intermediate insulating layer 312 can be fully bonded with the jacket 314.

Any number of conductor components can be cabled together to form the assembly. For example, the conductor components can be cabled together to form a triad-cable core, a quad-cable core, a hepta-cable core, or other suitable cable cores. In addition, the conductor components can have various sizes and profiles.

Any combination of the conductor components disclosed herein can be cabled together to form the assembly.

To make an assembly an intermediate insulating layer can be extruded about twisted conductor components. The intermediate insulating layer can be a polymer, such as a soft elastomer or thermoplastic. The intermediate insulating layer can be formed into a circular profile.

The jacket can be extruded about the intermediate insulating layer. The jacket can be a polymer. The jacket or intermediate layer can have fiber reinforcement. For example, strands of fiberglass, carbon fiber, or the like can be impregnated into the polymer to provide added strength to the jacket, intermediate layer, or both.

FIG. 4 depicts an example armored assembly having an example arrangement of strength members disposed thereabout. The armored assembly 400 includes an assembly 410. The assembly 410 can be any assembly of conductor components. For example, the assembly 410 can be similar to one described above.

Strength members 420 are arranged about the assembly 410, the strength members 420 can be bare counter-helically cable armor wires. The strength members can be steel, reinforced polymers, or the like.

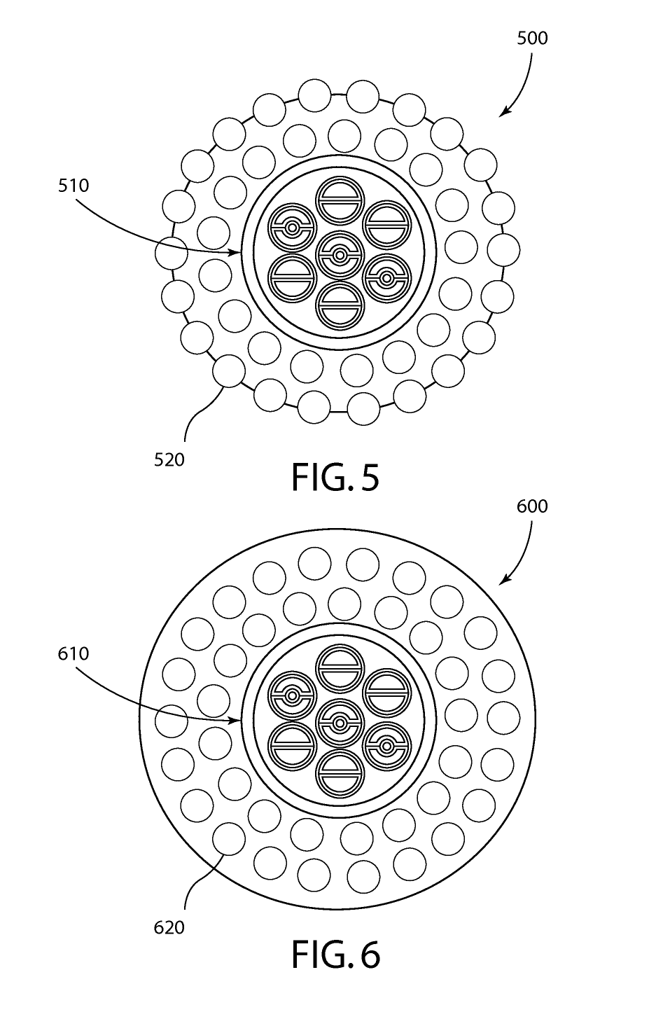

FIG. 5 depicts another example assembly having another example arrangement of strength members disposed thereabout. The armored assembly 500 includes an assembly 510. The assembly 510 can be similar to those described herein. The assembly 510 has partially jacketed strength members 520 disposed thereabout. The strength members can be layers of armor wires partially jacketed with polymer. The partially jacketed strength members 520 can be bonded to the assembly 510.

FIG. 6 depicts another example assembly having another example arrangement of strength members disposed thereabout. The armored assembly 600 includes an assembly 610. The assembly 610 can be similar to those disclosed herein. The assembly 610 has fully jacketed strength members 620 disposed thereabout. The fully jacketed strength members 620 can be armor wires jacketed in a polymer. The fully jacketed strength members 620 can be bonded with the assembly 610.

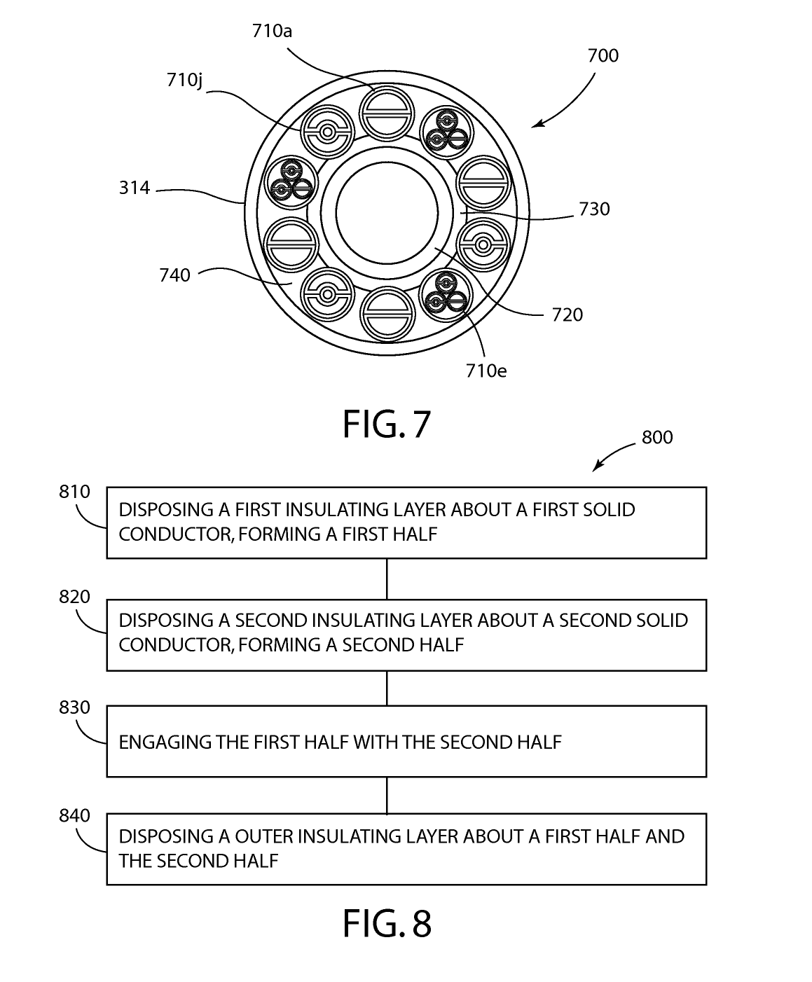

FIG. 7 depicts an example assembly of conductor components arranged about a tubular member. The assembly 700 can be used to provide electrical power, telemetry, or both to remote equipment, such as downhole equipment, submarines, mining equipment, or other remote equipment. The assembly 700 can also be used to provide gas, fluid, or both to remote equipment. For example, the assembly 700 can have hydraulic hoses, conduits, or the like incorporated therewith to allow for communication of gas or fluid from or to the remote equipment. The assembly 700 can provide a combination of telemetry, electrical power, gas, and fluid at the same to the remote equipment.

The assembly 700 can include a plurality of conductor components 710a to 710j; however, any number of conductor components can be used to form the assembly. Furthermore, some of the conductor components, such as fifth conductor component 710e, can be a subassembly of multiply conductor components.

The assembly 700 includes a tubular member 720. The tubular member 720 can be a metallic tubular member. An inner insulating layer 730 can be disposed about the tubular member 720. The inner insulating layer 730 can be any material. Illustrative materials for the inner insulating layer include Fluoropolymers, Polyolefins, Polyarylether ketone family polymers, Polyphenylene family polymers, high temperature cross-linked epoxy, or the like.

The conductor components 710a to 710j can be cabled about the inner insulating layer 730. For example, the conductor components 710a to 710j can be helically cabled about the inner insulating layer 730. The assembly 700 can be made without the inner insulating layer, and the conductor components 710a to 710j can be cabled around the tubular member 720.

Interstitial spaces are located between the conductors 710a to 710j and a filler 740 can be used to fill the interstitial spaces. The filler 740 can be a polymeric filler.

The jacket 314 can be disposed about the conductor components 710a to 710j. The jacket 314 can be a layer of polymer extruded over the conductors 710a to 710j. Any type of jacketed or unjacketed strength member system may be placed over the jacket 314 to provide an armored assembly. Cabling tape can be used to hold the conductors 710a to 710j in place as the jacket 314 is placed about them.

FIG. 8 depicts an example method of making a conductor component.

The method 800 is depicted as a plurality of blocks or operations. The method 800 includes disposing a first insulating layer about a first solid conductor, forming a first half (Block 810). For example, the first insulating layer can be a polymer that can be extruded about the first solid conductor. The first insulating layer can shape-extrude the first solid conductor.

The method 800 can also include disposing a second insulating layer about a second solid conductor, forming a second half (Block 820). For example, the second insulating layer can be a polymer that can be extruded about the second solid conductor. The second insulating layer can shape-extrude the second solid conductor.

The method 800 can also include engaging the first half with the second half (Block 830). The halves can be engaged to form a circular profile.

The method 800 can also include disposing an outer insulating layer about the first half and the second half (Block 840). The outer insulating layer can be a polymer that can be extruded about the engaged halves.

Although example conductor components, methods of making conductor components, and assemblies of conductor components have been described herein, the scope of coverage of this patent is not limited thereto. On the contrary, this patent covers every method, apparatus, and article of manufacture fairly falling within the scope of the appended claims either literally or under the doctrine of equivalents.

What is claimed is:

1. A conductor component comprising:
a first half comprising:
a first solid conductor; and
a first insulating layer disposed about the first solid conductor;
a second half comprising:
a second solid conductor; and
a second insulating layer disposed about the second solid conductor, wherein the first half is engaged with the second half; and
an outer insulating layer disposed about the first half and the second half.

2. The conductor component of claim 1, wherein the halves have a semi-circular profile.

3. The conductor component of claim 1, wherein the first half has a first concave portion, and the second half has a second concave portion, and wherein an opening is formed by the concave portions when the halves are engaged with one another.

4. The conductor component of claim 3, wherein an optical fiber is located in the opening.

5. An assembly of conductor components comprising:
a plurality of conductor components, wherein at least one of the conductor components of the plurality of conductor components comprises:
a first half comprising:
a first solid conductor; and
a first insulating layer disposed about the first solid conductor;
a second half comprising:
a second solid conductor; and
a second insulating layer disposed about the second solid conductor, wherein the first half is engaged with the second half; and
a jacketing disposed about the plurality of conductor components.

6. The assembly of claim 5, wherein the halves of each of the conductor components of the plurality of conductor components have a semi-circular profile.

7. The assembly of claim 5, wherein the first half of each of the conductor components of the plurality of conductor components has a first concave portion, and the second half of each of the conductor components of the plurality of conductor components has a second concave portion, and wherein an opening is formed by the concave portions when the halves are engaged with one another.

8. The assembly of claim 7, wherein an optical fiber is located in the opening of each of the conductor components of the plurality of conductor components.

9. The assembly of claim 5, wherein the plurality of conductor components comprises:
a first solid conductor component having halves with a semi-circular profile; and
a second solid conductor component having halves with concave portions, wherein the concave portions form an opening, and wherein an optical fiber is located in the opening.

10. The assembly of claim 5, further comprising:
an intermediate insulating layer disposed about the plurality of conductor components, wherein the intermediate insulating layer is located between the jacketing and the plurality of conductor components.

11. The assembly of claim 10, wherein the conductor components are arranged in a twisted pair design, and wherein the jacketing has a circular profile.

12. The assembly of claim 5, wherein the plurality of conductor components are disposed about a tubular member.

13. The assembly of claim 12, wherein an inner insulating layer is disposed about the tubular member, and wherein the inner insulating layer is located between the tubular member and the plurality of conductor components.

14. The assembly of claim 13, wherein the plurality of conductor components are cabled helically about the inner insulating layer.

15. A method of making a conductor component comprising:
disposing a first insulating layer about a first solid conductor, forming a first half;
disposing a second insulating layer about a second solid conductor, forming a second half;
engaging the first half with the second half; and
disposing an outer insulating layer about the first half and the second half.
